(19) United States
(12) Patent Application Publication
(10) Pub. No.: US 2025/0223176 A1
(43) Pub. Date: Jul. 10, 2025

(54) CARBON DIOXIDE SEQUESTRATION IN SALT MINIBASINS USING CARBONATED AQUEOUS FLUIDS

(71) Applicant: SAUDI ARABIAN OIL COMPANY, Dhahran (SA)

(72) Inventors: Markus ALBERTZ, The Woodlands, TX (US); Rajesh GOTETI, Katy, TX (US)

(73) Assignee: SAUDI ARABIAN OIL COMPANY, Dhahran (SA)

(21) Appl. No.: 18/409,634

(22) Filed: Jan. 10, 2024

(51) Int. Cl. C01B 32/50

(52) U.S. Cl. CPC C01B 32/50

(57) ABSTRACT

Methods for carbon dioxide sequestration may comprise: providing a carbonated aqueous fluid containing carbon dioxide dissolved in a first aqueous fluid; and introducing the carbonated aqueous fluid into a salt minibasin containing a second aqueous fluid having a density that is less than that of the carbonated aqueous fluid, the salt minibasin having a salt barrier defining one or more boundaries thereof. The second aqueous fluid is displaced upward as the carbonated aqueous fluid is being introduced to the salt minibasin to form a barrier layer overlaying the carbonated aqueous fluid, and the barrier layer and the salt barrier maintain the carbonated aqueous fluid within the salt minibasin. In one example, the salt minibasin may be an open salt minibasin having a concave shape.

### FIELD OF THE DISCLOSURE

The present disclosure relates generally to carbon dioxide sequestration and, more particularly, to methods and systems facilitating carbon dioxide sequestration in salt minibasins.

### BACKGROUND OF THE DISCLOSURE

Carbon dioxide (CO₂) is a greenhouse gas that contributes to global atmospheric warming. With carbon dioxide emissions continuing to increase as a consequence of human activities, there has been growing interest in ways to remove carbon dioxide from the atmosphere and then sequester the carbon dioxide for long-term storage.

Several approaches for sequestering carbon dioxide in geological formations have received considerable study. Among these approaches are 1) CO₂ storage in depleted oil and gas reservoirs, 2) CO₂ injection into deep saline aquifers, 3) CO₂ injection into coal seams, 4) CO₂ retention during enhanced oil recovery (EOR), and 5) carbon mineralization (carbonate production) within a formation. The requirements for sequestering carbon dioxide in a geological formation are similar in many respects to the factors promoting ready retention and production of a hydrocarbon resource. Namely, the formation matrix needs to have adequate porosity and permeability to promote fluid storage, and a trapping configuration below a sealing rock (cap rock) usually needs to be present to maintain the fluid within the geological formation over the long term. That is, the factors that may promote long-term retention of a hydrocarbon resource within a geological formation may similarly promote retention of carbon dioxide as well. Natural buoyancy of carbon dioxide can make retention problematic in many instances, especially if a suitable trapping configuration is not present. Carbon mineralization resolves the buoyancy issue by forming carbon-containing solids naturally or via accelerated mineralization chemistries to produce calcium, magnesium, or iron carbonate solids that are usually identical to the naturally occurring minerals. However, carbon mineralization methods are not as well developed at this juncture relative to approaches for sequestering fluids comprising carbon dioxide.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, methods for carbon dioxide sequestration comprise: providing a carbonated aqueous fluid containing carbon dioxide dissolved in a first aqueous fluid; and introducing the carbonated aqueous fluid into a salt minibasin containing a second aqueous fluid having a density that is less than that of the carbonated aqueous fluid, the salt minibasin having a salt barrier defining one or more boundaries thereof; wherein the second aqueous fluid is displaced upward as the carbonated aqueous fluid is being introduced to the salt minibasin to form a barrier layer overlaying the carbonated aqueous fluid, and the barrier layer and the salt barrier maintain the carbonated aqueous fluid within the salt minibasin.

In another embodiment, methods for carbon dioxide sequestration comprise: providing a carbonated aqueous fluid containing carbon dioxide dissolved in a first aqueous fluid, the carbonated aqueous fluid comprising a carbonated brine or a carbonated aqueous salt solution; and introducing the carbonated aqueous fluid into an open salt minibasin having a concave shape and a salt barrier defining one or more boundaries of the open salt minibasin, the open salt minibasin containing a formation water that is native to the open salt minibasin and has a density that is less than that of the carbonated aqueous fluid; wherein the formation water is displaced upward as the carbonated aqueous fluid is being introduced to the open salt minibasin to form a barrier layer overlaying the carbonated aqueous fluid, and the barrier layer and the salt barrier maintain the carbonated aqueous fluid within the open salt minibasin.

In yet still another embodiment, methods for carbon dioxide sequestration comprise: providing a carbonated aqueous fluid containing carbon dioxide dissolved in a first aqueous fluid; introducing the carbonated aqueous fluid into a salt minibasin having a salt barrier defining one or more boundaries thereof; and introducing a second aqueous fluid into the salt minibasin before or after the carbonated aqueous fluid, the second aqueous fluid having a density lower than that of the carbonated aqueous fluid, and the second aqueous fluid forming a barrier layer overlaying the carbonated aqueous fluid in the salt minibasin; wherein the barrier layer and the salt barrier maintain the carbonated aqueous fluid within the salt minibasin.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram of an illustrative open salt minibasin.

FIG. 2 is a diagram of an illustrative encapsulated salt minibasin.

FIG. 3 is a diagram showing how carbon dioxide may be sequestered in an open salt minibasin in accordance with the disclosure herein.

FIG. 4 is a process flow diagram showing further operations that may take place in the course of introducing a carbonated aqueous fluid into a salt minibasin in accordance with disclosure herein.

### DETAILED DESCRIPTION

Embodiments in accordance with the present disclosure generally relate to carbon dioxide sequestration and, more particularly, to methods and systems facilitating carbon dioxide sequestration in salt minibasins.

As discussed above, there is increasing interest in carbon dioxide sequestration to mitigate the effects of atmospheric global warming. Several approaches have been developed to promote carbon dioxide sequestration in geological formations of various types. Although these sequestration approaches may be successful to varying degrees, there is still a need for alternative approaches for promoting geological sequestration of carbon dioxide.

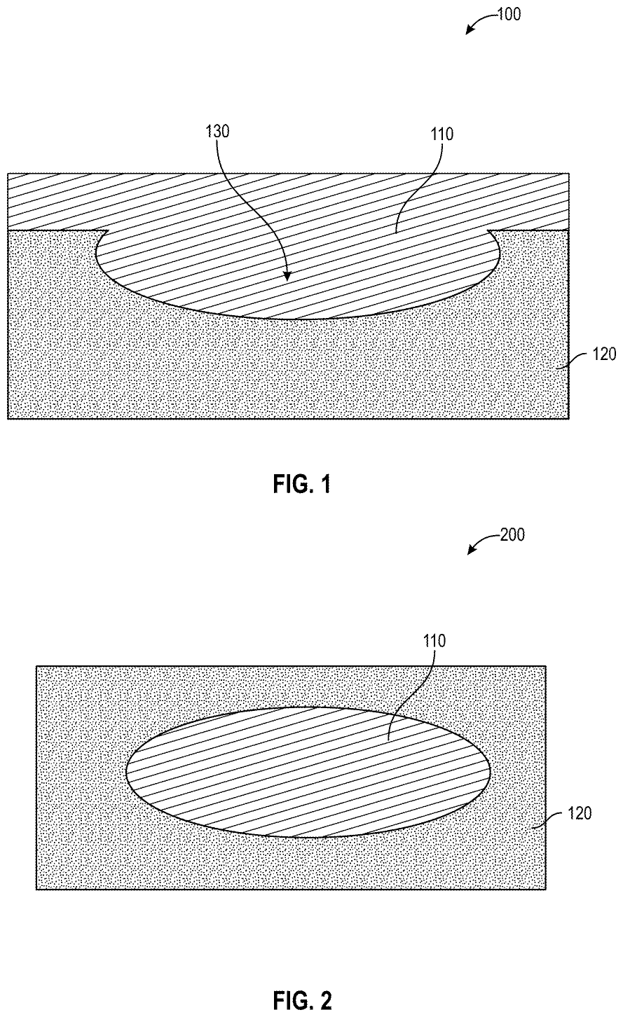

The present disclosure provides various approaches for sequestering carbon dioxide in salt minibasins (also sometimes referred to as salt withdrawal basins or salt expulsion basins). As used herein, the term “salt minibasin” refers to a sedimentary rock deposit that has sunk into a surrounding salt layer. The salt layer forms a dense barrier around the sedimentary rock deposit. Salt minibasins usually have a largest dimension of only a few tens of kilometers (e.g., about 100 km or less, or about 90 km or less, or about 80 km or less, or about 70 km or less, or about 60 km or less, or about 50 km or less) and are distinguished in at least this respect from ordinary sedimentary basins which may be distributed over a much larger geological region. There are two types of salt minibasins: open salt minibasins having a concave (bowl) shape, and encapsulated salt minibasins. FIG. 1 is a diagram of an illustrative open salt minibasin. As shown, open salt minibasin 100 includes sedimentary rock deposit 110 which is partially surrounded by salt barrier 120. Specifically, sedimentary rock deposit 110 is surrounded laterally and beneath by salt barrier 120, but the top of concave portion 130 is open, such that there is no discrete trapping configuration for maintaining fluids therein. FIG. 2 is a diagram of an illustrative encapsulated salt minibasin. Encapsulated salt minibasin 200 is similar to open salt minibasin 100, except salt barrier 120 completely surrounds sedimentary rock deposit 110. In encapsulated salt minibasin 200, the upper portion of salt barrier 120 forms a trapping configuration above sedimentary rock deposit 110, which is not present in open salt minibasin 100 (FIG. 1).

Using salt minibasins for promoting sequestration of carbon dioxide may be advantageous for a number of reasons. Foremost, the salt barrier at least partially surrounding the sedimentary rock deposit in salt minibasins is very impermeable and may aid in retaining carbon dioxide trapped in various forms within the high porosity of the sedimentary rock deposit. In addition, salt minibasins are commonly occurring geological structures throughout the world (numerous salt minibasins are found in the Gulf of Mexico, for instance), and some may have existing equipment previously used for producing a hydrocarbon resource from the sedimentary rock deposit. The existing production equipment may be modified for introducing carbon dioxide in a suitable form into the sedimentary rock deposit according to the disclosure herein, thereby providing beneficial cost savings. Other types of salt minibasins do not contain (or never contained) a hydrocarbon resource but may still be utilized for carbon dioxide sequestration after installing appropriate equipment for introducing carbon dioxide thereto according to the disclosure herein.

Encapsulated salt minibasins may be used to sequester carbon dioxide in any of a variety of forms due to the closed salt barrier surrounding the sedimentary rock deposit. Although at first glance it appears that carbon dioxide may not be effectively sequestered in open salt minibasins due to carbon dioxide's buoyancy and lack of a trapping configuration, carbon dioxide may, in fact, be sequestered in these types of salt minibasins as well if introduced in a suitable form. Specifically, in the present disclosure, if carbon dioxide is introduced to an open salt minibasin in a carbonated aqueous fluid that is more dense than existing formation water (or a separately introduced aqueous fluid), the carbonated aqueous fluid may sink to the bottom of the sedimentary rock deposit, and the formation water (or the separately introduced aqueous fluid) may overlay the carbonated aqueous fluid as a discrete barrier layer. The barrier layer may effectively trap the more dense carbonated aqueous fluid in the bottom portion of the sedimentary rock deposit, where it is further surrounded by the salt barrier (below and laterally) and retained within the concavity of the sedimentary rock deposit. Thus, the carbonated aqueous fluid is negatively buoyant, since it sinks in the formation water and displaces the formation water upward to define the barrier layer, with the barrier layer providing a trapping configuration for the carbonated aqueous fluid located below.

Carbon dioxide sequestration in open salt minibasins is facilitated by a density increase that occurs upon dissolving carbon dioxide into aqueous fluids of various types. For example, saturating a brine with carbon dioxide affords a 2-3% increase in density relative to the uncarbonated brine. Depending on the density of the formation water in the open salt minibasin (or other aqueous fluid introduced separately to the open salt minibasin), an appropriate aqueous fluid source may be selected to convey a density to the resulting carbonated aqueous fluid that is sufficiently greater than that of the formation water (or other aqueous fluid introduced separately to the open salt minibasin) to drive the carbonated aqueous fluid to the bottom of the sedimentary rock deposit. Various aqueous fluids ranging from fresh water to aqueous salt solutions to high-salinity brines, or combinations thereof, may be utilized to form the carbonated aqueous fluid, depending on the density required to provide the carbonated aqueous fluid with negative buoyancy. Further description concerning suitable aqueous fluid sources and selection thereof is provided in additional detail hereinbelow.

Accordingly, carbon dioxide sequestration methods of the present disclosure may comprise: providing a carbonated aqueous fluid containing carbon dioxide dissolved in a first aqueous fluid; and introducing the carbonated aqueous fluid into a salt minibasin containing a second aqueous fluid having a density that is less than that of the carbonated aqueous fluid, the salt minibasin having a salt barrier defining one or more boundaries thereof. The second aqueous fluid is displaced upward as the carbonated aqueous fluid is being introduced to the salt minibasin to form a barrier layer overlaying the carbonated aqueous fluid, and the barrier layer and the salt barrier maintain the carbonated aqueous fluid within the salt minibasin.

The second aqueous fluid within the salt minibasin may comprise formation water that is native to the salt minibasin. The formation water may comprise a brine in some instances.

Alternately, the second aqueous fluid may be introduced to the salt minibasin, either before or after the carbonated aqueous fluid is introduced. The second aqueous fluid introduced to the salt minibasin may be substantially uncarbonated. A second aqueous fluid may be introduced to the salt minibasin if there is insufficient formation water to form an effective barrier layer over the carbonated aqueous fluid or if the salinity of the formation water needs to be adjusted to change the density in order for the carbonated aqueous fluid to be sufficiently negatively buoyant once introduced to the salt minibasin. When a second aqueous fluid is introduced to the salt minibasin, the second aqueous fluid may be drawn from any aqueous fluid source suitable for forming the carbonated aqueous fluid. Suitable aqueous fluid sources are discussed in further detail below.

The salt minibasin to which the carbonated aqueous fluid is introduced may be an open salt minibasin having a concave shape, since the carbonated aqueous fluid may be effectively contained within the concavity of the open salt minibasin by the barrier layer. The barrier layer may provide a trapping configuration to prevent leakage of the carbonated aqueous fluid from the top of the open salt minibasin. Thus, open salt minibasins may effectively sequester carbon dioxide in accordance with the disclosure herein without a caprock or similar geological seal being present. The salt barrier, in combination with the barrier layer, may otherwise maintain the carbonated aqueous fluid in the open salt minibasin.

In alternative embodiments, the carbonated aqueous fluid may be introduced to an encapsulated salt minibasin and then overlaid by a barrier layer. In the case of an encapsulated salt minibasin, the salt barrier surrounding the upper portion of the sedimentary rock deposit may supplement the barrier layer in promoting retention of the carbonated aqueous fluid in the porosity of the sedimentary rock deposit.

The salt minibasin is not producing a hydrocarbon resource when the carbonated aqueous fluid is being introduced thereto. The salt minibasin may or may not have previously produced a hydrocarbon resource (or never contained a hydrocarbon resource), but if the salt minibasin previously produced a hydrocarbon resource, the hydrocarbon resource is no longer being produced from the salt minibasin once the carbonated aqueous fluid is being introduced thereto. Preferably, the salt minibasin may be substantially devoid (absent) of a producible hydrocarbon resource. Absence of a hydrocarbon resource in the salt minibasin may leave the porosity of the sedimentary rock deposit available for storage of carbon dioxide dissolved in the carbonated aqueous fluid in accordance with the disclosure herein.

The carbonated aqueous fluid may be provided by dissolving carbon dioxide in a suitable aqueous fluid to convey a density to the carbonated aqueous fluid that is greater than that of the second aqueous fluid (either formation water or a separately introduced aqueous fluid) in the salt minibasin. The aqueous fluid used to form the carbonated aqueous fluid may therefore be selected to provide a density greater than that of the second aqueous fluid present in the salt minibasin. When forming the carbonated aqueous fluid, the aqueous fluid may be selected based upon its initial density and taking into account a 2-3% density increase upon dissolving carbon dioxide in the aqueous fluid to form the carbonated aqueous fluid for introduction to the salt minibasin. Depending on the density of the second aqueous fluid, the source for the aqueous fluid used to form the carbonated aqueous fluid may include, for example, fresh water (e.g., stream water, lake water, or municipal treated water), non-potable water such as gray water or industrial process water, sea water, brine, aqueous salt solutions, partially desalinated water, produced water (including brine and other salt water solutions), or any combination thereof. Produced water may include formation water obtained from the salt minibasin, formation water or flowback water produced from nearby a hydrocarbon-producing well, or the like. As used herein, the term “brine” refers to a saturated aqueous salt solution. An “aqueous salt solution” has a salt concentration (salinity) less than that of brine. When produced formation water is used to form the carbonated aqueous fluid, at least a portion of the second aqueous fluid may be withdrawn (as produced formation water) from the salt minibasin prior to or concurrently with introducing the carbonated aqueous fluid to the salt minibasin, and at least some of the second aqueous fluid withdrawn from the salt minibasin may be combined with carbon dioxide to form at least a portion of the carbonated aqueous fluid. Optionally, when using produced formation water to generate the carbonated aqueous fluid, another aqueous fluid (e.g., a brine or an aqueous salt solution having a higher density than that of the formation water) may be combined with the formation water in various proportions to convey a sufficient density increase to the carbonated aqueous fluid.

Any of the foregoing water sources may be utilized to introduce second aqueous fluid to the salt minibasin in lieu of using formation water natively present in the salt minibasin to form the barrier layer overlaying the carbonated aqueous fluid.

In some instances, formation water may be withdrawn from the salt minibasin without using the produced formation water to form the carbonated aqueous fluid or a portion thereof. If excessive formation water is present in pore space that might otherwise be filled with the carbonated aqueous fluid, a portion of the formation water may be withdrawn in the foregoing manner. That is, a portion of the formation water may be withdrawn in some instances to create storage space for carbon dioxide in the salt minibasin and/or to regulate pressure in the salt minibasin.

As a non-limiting example of the foregoing, the carbonated aqueous fluid may be produced by dissolving carbon dioxide in a first brine and the second aqueous fluid may comprise formation water that is a second brine. The first brine may be selected to have a density at least equal and preferably greater than the density of the second brine comprising the formation water to convey a sufficiently high density to the carbonated aqueous fluid. As another non-limiting example, if the carbonated aqueous fluid is formed from produced formation water, a brine or an aqueous salt solution may be combined in various proportions with the produced formation water to increase the density of the carbonated aqueous fluid sufficiently to convey negative buoyancy. That is, the second aqueous fluid (produced formation water) withdrawn from the salt minibasin may be combined with another aqueous fluid having a higher density than that of the second aqueous fluid to form a combined aqueous fluid, and then using the combined aqueous fluid to form the carbonated aqueous fluid. When formation water is produced and used to form the carbonated aqueous fluid in combination with another aqueous fluid, the formation water may be combined with the other aqueous fluid in a volume ratio ranging from about 1:99 to about 99:1, depending on the targeted density of the carbonated aqueous fluid and the densities of the formation water and the other aqueous fluid.

Accordingly, in some embodiments, the carbonated aqueous fluid may comprise a carbonated brine or a carbonated aqueous salt solution. As non-limiting examples, carbonated aqueous salt solutions may be formed by introducing carbon dioxide to an aqueous salt solution, a mixture of brine and an aqueous salt solution, a mixture of brine and fresh water or other water source having a low salinity, or the like. Any of the foregoing may comprise produced formation water. Preferably, when mixing produced formation water with an aqueous salt solution or brine in the course of forming the carbonated aqueous fluid, the aqueous salt solution or brine may have a salinity of about 1,000 ppm greater than the formation water, or about 2,000 ppm or greater, or about 3,000 ppm or greater, or about 4,000 ppm or greater, or about 5,000 ppm or greater, or about 6,000 ppm or greater, or about 7,000 ppm or greater, or about 8,000 ppm or greater, or about 9,000 ppm or greater, or about 10,000 ppm or greater. The higher salinity of the aqueous fluid combined with the formation water may aid in ensuring that the carbonated aqueous fluid has sufficient salinity to be negatively buoyant with respect to the formation water. Alternately, the carbonated aqueous fluid may have a density that is at least about 2% higher than the formation water, or at least about 3% higher than the formation water, or at least about 4% higher than the formation water, or at least about 5% higher than the formation water.

Optionally, the density of the carbonated aqueous fluid may be further increased via a densifying additive if a sufficient density increase in the carbonated aqueous fluid may not be realized using the available aqueous fluids at the site of a given salt minibasin. The densifying additive may be dissolved or suspended in the carbonated aqueous fluid to convey a further density increase over that afforded by the dissolved carbon dioxide alone. Suitable densifying additives may include common weighting agents utilized in the oilfield services industry such as, for example, barite, hematite, calcium carbonate, and siderite. Other suitable densifying additives include gels (e.g., water-soluble polymers that may be optionally crosslinked with one another), and a plurality of fines that are intentionally added to the carbonated aqueous fluid for densification purposes. Nanoparticles may be used as a densifying additive in some instances.

The carbon dioxide may be dissolved in the chosen aqueous fluid in any suitable manner to provide the resulting carbonated aqueous fluid for introduction to the salt minibasin. In some embodiments, the carbon dioxide may be dissolved in a surface facility in fluid communication with an injection well penetrating the salt minibasin. In other embodiments, the carbon dioxide may be dissolved in a suitable aqueous fluid as the carbon dioxide and the aqueous fluid are being introduced into the salt minibasin via an injection well penetrating the salt minibasin. In either case, suitable dissolution techniques may involve pressurized mixing of the carbon dioxide with the aqueous fluid to form the carbonated aqueous fluid or simply by bubbling or injecting the carbon dioxide into the aqueous fluid or a stream of the aqueous fluid. Preferably, the carbonated aqueous fluid may be saturated or nearly saturated with carbon dioxide under the mixing conditions, such that a maximum increase in density and maximum amount of carbon dioxide storage may be realized. It is to be appreciated, however, that sub-saturation amounts of carbon dioxide also reside within the scope of the present disclosure and may be appropriate depending on circumstances.

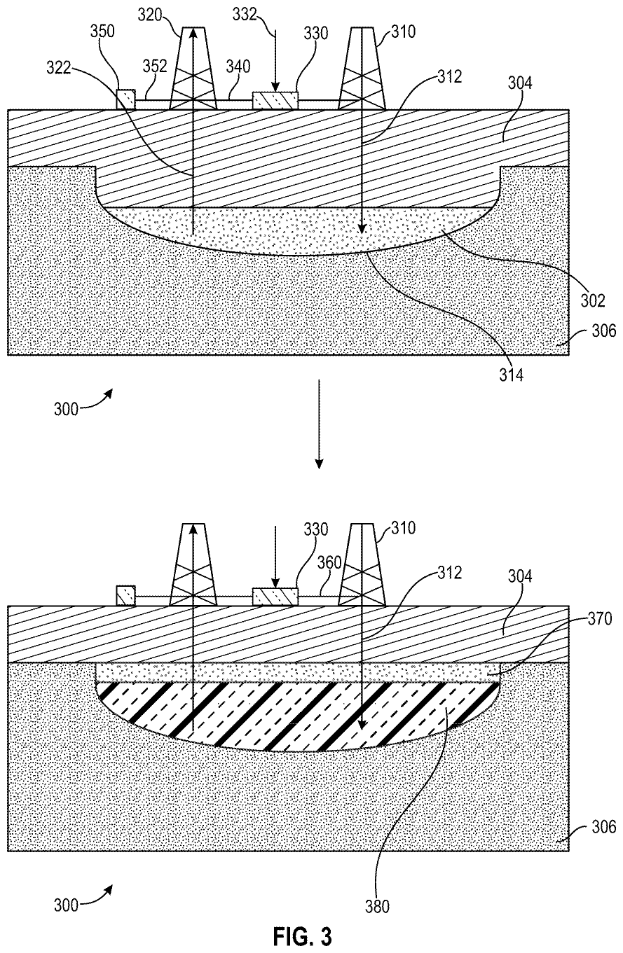

FIG. 3 is a diagram showing how carbon dioxide may be sequestered in an open salt minibasin in accordance with the disclosure herein. As shown, open salt minibasin 300, which is similar to open salt minibasin 100 in FIG. 1, contains formation water 302 within sedimentary rock deposit 304. Sedimentary rock deposit 304 is partially surrounded by salt barrier 306 but is not enclosed by salt barrier 306 proximal to earth's surface 308. Injection well 310 penetrates sedimentary rock deposit 304 and wellbore 312 extends at least into formation water 302, and preferably wellbore 312 terminates near or adjacent to bottom surface 314 of sedimentary rock deposit 304. Production well 320 optionally penetrates sedimentary rock deposit 304 and is configured to withdraw a portion of formation water 302 from sedimentary rock deposit 304 via wellbore 322. If present, production well 320 may be repurposed from prior hydrocarbon resource production, or production well 320 may be newly constructed to facilitate introduction of carbonated aqueous fluid to open salt minibasin 300 in accordance with the disclosure herein. Injection well 310 may likewise have been repurposed from prior hydrocarbon resource production or newly constructed to facilitate introduction of carbonated aqueous fluid to open salt minibasin 300 in accordance with the disclosure herein.

Surface facility 330 may promote mixing of carbon dioxide with a suitable aqueous fluid to form the carbonated aqueous fluid for injection into open salt minibasin 300 via wellbore 312. The aqueous fluid mixed with carbon dioxide in surface facility 330 may be obtained from an external source and delivered by line 332, and/or at least some of the aqueous fluid delivered to surface facility 330 may comprise formation water 302 withdrawn via wellbore 322. If formation water 302 is withdrawn, it may be delivered to surface facility 330 via line 340 to form the carbonated aqueous fluid. Alternately, formation water 302 may be delivered to disposal location 350 via line 352. Disposal location 350 may include a vehicle, holding tank or pond, other injection well, or any combination thereof. Withdrawal of formation water 302 without forming carbonated aqueous fluid therefrom may take place, for example, when excess formation water 302 is present in open salt minibasin 300 and additional storage capacity for the carbonated aqueous fluid needs to be created and/or formation water 302 may not suitably be used to form a carbonated aqueous fluid having a sufficient density when mixed with an aqueous fluid originating from another source (e.g., an externally sourced brine or aqueous salt solution).

As a carbonated aqueous fluid is produced in surface facility 330, the carbonated aqueous fluid is conveyed by line 360 to wellbore 312 for delivery to open salt minibasin 300. Although not shown in FIG. 3, carbon dioxide and a suitable aqueous fluid may be mixed in a wellhead of injection well 310 and/or wellbore 312 to promote delivery of carbonated aqueous fluid to open salt minibasin 300.

Once the carbonated aqueous fluid is delivered to open salt minibasin 300, the carbonated aqueous fluid displaces the formation water upwardly to afford barrier layer 370 overlaying carbonated aqueous fluid layer 380, which is more dense than barrier layer 370. Carbonated aqueous fluid layer 380 comprises the carbonated aqueous fluid introduced via wellbore 312. Since barrier layer 370 overlays carbonated aqueous fluid layer 380, the carbonated aqueous fluid is precluded from migrating upwardly and escaping open salt minibasin 300. Moreover, because carbonated aqueous fluid layer 380 remains surrounded by salt barrier 306, the carbonated aqueous fluid remains confined within the concavity of open salt minibasin 300.

Accordingly, more specific embodiments of the present disclosure may comprise: providing a carbonated aqueous fluid containing carbon dioxide dissolved in a first aqueous fluid, the carbonated aqueous fluid comprising a carbonated brine or a carbonated aqueous salt solution; and introducing the carbonated aqueous fluid into an open salt minibasin having a concave shape and a salt barrier defining one or more boundaries of the open salt minibasin, the open salt minibasin containing a formation water that is native to the open salt minibasin and has a density that is less than that of the carbonated aqueous fluid. The formation water is displaced upward as the carbonated aqueous fluid is being introduced to the open salt minibasin to form a barrier layer overlaying the carbonated aqueous fluid, and the barrier layer and the salt barrier maintain the carbonated aqueous fluid within the open salt minibasin.

Optionally, at least a portion of the carbonated aqueous fluid may be generated from the formation water. Accordingly, the methods may further comprise: withdrawing a portion of the formation water from the open salt minibasin prior to or concurrently with introducing the carbonated aqueous fluid to the open salt minibasin. Moreover, the methods may further comprise combining at least some of the formation water withdrawn from the open salt minibasin with carbon dioxide to form at least a portion of the carbonated aqueous fluid. Optionally, the formation water may be further combined with another aqueous fluid having a higher density than that of the formation water to form the carbonated aqueous fluid.

In the course of sequestering carbon dioxide in a salt minibasin in accordance with the disclosure above, various additional operations may be undertaken to identify suitable salt minibasins for carbon dioxide storage, to determine an aqueous fluid suitable for forming a carbonated aqueous fluid for injection in a specified salt minibasin, and the like.

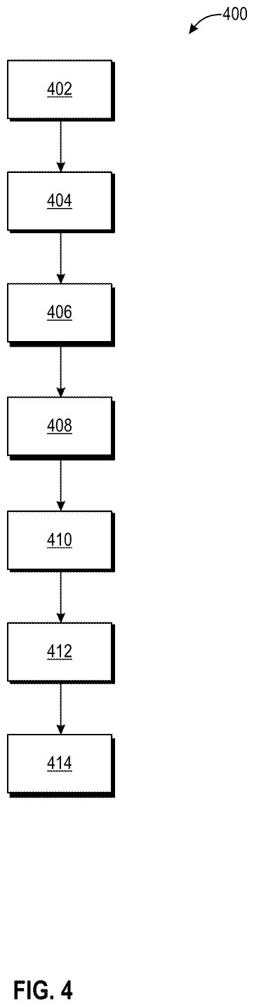

FIG. 4 is a process flow diagram showing further operations that may take place in the course of introducing a carbonated aqueous fluid into a salt minibasin (preferably an open salt minibasin) in accordance with disclosure herein. It is to be appreciated that the process flow depicted in FIG. 4 is illustrative and non-limiting. Not every operation depicted in FIG. 4 is necessarily conducted in each instance of introducing a carbonated aqueous fluid to a salt minibasin. Moreover, in some instances, additional operations further to those depicted in FIG. 4 may take place and/or the order of operations may take place in an order different from that depicted in FIG. 4.

As shown in FIG. 4, process 400 may include identifying 402 one or more salt minibasins using standard seismic techniques. Mapping 404 of the one or more minibasins may then be conducted. Parameters determined during mapping may include, for example, dimensions and volume of the salt minibasin, depth of the sedimentary rock deposit below the mudline, depth of the salt barrier at various locations, and the like. Mapping 404 may further include identifying portions of an injection interval that are not in contact with features indicative of prior fluid flow associated with a hydrocarbon resource. By avoiding an injection interval indicative of prior fluid flow, a “leaky” minibasin or a portion thereof may be avoided, thereby promoting carbon dioxide retention within the minibasin. Such measurements may also be determined by standard seismic techniques that will be familiar to one having ordinary skill in the art.

Once the one or more salt minibasins have been suitably analyzed by mapping 404, the carbon dioxide storage capacity may be calculated 406 in accordance with Equation 1

$${G}_{{CO}_{2}} = {A}_{t} {h}_{g} {∅}_{t} ρ {E}_{saline} \qquad Equation 1$$

wherein G_{CO}_{₂} is the mass estimate of carbon dioxide storage, Aₜ is total area being assessed for carbon dioxide storage, hg is the gross thickness of the region defined by Aₜ, ϕ is the total porosity of the sedimentary rock deposit, p is the density of carbon dioxide under the conditions present in the salt minibasin, and Eₛₐₗᵢₙₑ is the carbon dioxide storage efficiency factor. Eₛₐₗᵢₙₑ represents the fraction of the total pore volume that is filled with carbon dioxide. Eₛₐₗᵢₙₑ is defined as the volume fraction of the available subsurface space for CO₂ storage and has several components that reflect different physical barriers that inhibit CO₂ from contacting all of the pore volume of a given basin or region (see Wang, Y. et al., “Numerical investigation of the storage efficiency factor for CO₂ geological sequestration in saline formations,” Energy Procedia, 2013, pp. 5267-5274, 37.)

Next, the composition and/or density of the formation water may be analyzed or estimated 408 using standard sampling and laboratory testing procedures. Available aqueous fluid sources may be identified and selected 410 to provide a greater density in the carbonated aqueous fluid than in the formation water. Suitable aqueous fluid sources are specified in more detail above.

If not already present, an injection well or a production well may be drilled in the salt minibasin to deliver carbonated aqueous fluid to the sedimentary rock deposit and optionally to withdraw at least a portion of the formation water from the sedimentary rock deposit. The salt minibasin may undergo logging 412 using standard well logging techniques from the injection well, the production well, or a nearby offset well. For example, logging may be conducted by standard wireline analyses, drill cutting analyses, or core analyses (including sidewall cores or whole cores) to confirm the prior seismic analyses. Parameters such as porosity and permeability of the salt minibasin may be determined during logging 412. The data from logging 412 and mapping 404 may be further analyzed 414 to determine stratigraphic layering, such as the number and location of storage units and seal units (if any) within the salt minibasin, using industry-standard techniques from the petroleum industry.

Once the salt minibasin has been satisfactorily characterized and confirmed to be suitable for promoting carbon dioxide sequestration in accordance with the disclosure herein, the carbonated aqueous fluid may be produced and injected (see FIG. 3), while monitoring pressure within the salt minibasin.

In alternative embodiments of the present disclosure, an aqueous fluid may be introduced to a salt minibasin before or after a carbonated aqueous fluid, wherein the aqueous fluid has a lower density than does the carbonated aqueous fluid also being introduced to the salt minibasin. Introduction of a lower-density aqueous fluid may be performed when the salt minibasin does not contain a suitable formation water and/or the amount of formation water in the salt minibasin is inadequate to produce a barrier water layer of sufficient thickness or weight to retain the carbonated aqueous fluid within the salt minibasin. Such methods may comprise: providing a carbonated aqueous fluid containing carbon dioxide dissolved in a first aqueous fluid; introducing the carbonated aqueous fluid into a salt minibasin having a salt barrier defining one or more boundaries thereof; and introducing a second aqueous fluid into the salt minibasin before or after the carbonated aqueous fluid, the second aqueous fluid having a density lower than that of the carbonated aqueous fluid, and the second aqueous fluid forming a barrier layer overlaying the carbonated aqueous fluid in the salt minibasin. The barrier layer and the salt barrier maintain the carbonated aqueous fluid within the salt minibasin in a similar manner to that described in further detail above.

Embodiments disclosed herein include:

A. Methods for carbon dioxide sequestration. The methods comprise: providing a carbonated aqueous fluid containing carbon dioxide dissolved in a first aqueous fluid; and introducing the carbonated aqueous fluid into a salt minibasin containing a second aqueous fluid having a density that is less than that of the carbonated aqueous fluid, the salt minibasin having a salt barrier defining one or more boundaries thereof; wherein the second aqueous fluid is displaced upward as the carbonated aqueous fluid is being introduced to the salt minibasin to form a barrier layer overlaying the carbonated aqueous fluid, and the barrier layer and the salt barrier maintain the carbonated aqueous fluid within the salt minibasin.

B. Methods for carbon dioxide sequestration. The methods comprise: providing a carbonated aqueous fluid containing carbon dioxide dissolved in a first aqueous fluid, the carbonated aqueous fluid comprising a carbonated brine or a carbonated aqueous salt solution; and introducing the carbonated aqueous fluid into an open salt minibasin having a concave shape and a salt barrier defining one or more boundaries of the open salt minibasin, the open salt minibasin containing a formation water that is native to the open salt minibasin and has a density that is less than that of the carbonated aqueous fluid; wherein the formation water is displaced upward as the carbonated aqueous fluid is being introduced to the open salt minibasin to form a barrier layer overlaying the carbonated aqueous fluid, and the barrier layer and the salt barrier maintain the carbonated aqueous fluid within the open salt minibasin.

C. Methods for carbon dioxide sequestration. The methods comprise: providing a carbonated aqueous fluid containing carbon dioxide dissolved in a first aqueous fluid; introducing the carbonated aqueous fluid into a salt minibasin having a salt barrier defining one or more boundaries thereof; and introducing a second aqueous fluid into the salt minibasin before or after the carbonated aqueous fluid, the second aqueous fluid having a density lower than that of the carbonated aqueous fluid, and the second aqueous fluid forming a barrier layer overlaying the carbonated aqueous fluid in the salt minibasin; wherein the barrier layer and the salt barrier maintain the carbonated aqueous fluid within the salt minibasin.

Each of embodiments A-C may have one or more of the following additional elements in any combination:

Element 1: wherein the salt minibasin is an open salt minibasin having a concave shape.

Element 2: wherein the second aqueous fluid within the salt minibasin comprises a formation water that is native to the salt minibasin.

Element 3: wherein the formation water comprises a brine.

Element 4: wherein the carbonated aqueous fluid comprises a carbonated brine or a carbonated aqueous salt solution.

Element 5: wherein the method further comprises withdrawing a portion of the second aqueous fluid from the salt minibasin prior to or concurrently with introducing the carbonated aqueous fluid to the salt minibasin.

Element 6: wherein the method further comprises combining at least some of the second aqueous fluid withdrawn from the salt minibasin with carbon dioxide to form at least a portion of the carbonated aqueous fluid.

Element 7: wherein the method further comprises combining the second aqueous fluid withdrawn from the salt minibasin with another aqueous fluid having a density higher than that of the second aqueous fluid to form a combined aqueous fluid; and using the combined aqueous fluid as the first aqueous fluid to form the carbonated aqueous fluid.

Element 8: wherein providing the carbonated aqueous fluid comprises dissolving carbon dioxide in the first aqueous fluid at a surface facility in fluid communication with an injection well penetrating the salt minibasin.

Element 9: wherein providing the carbonated aqueous fluid comprises dissolving carbon dioxide in the first aqueous fluid as the carbon dioxide and the one or more first aqueous fluids are being introduced to the salt minibasin via an injection well.

Element 10: wherein the salt minibasin previously produced a hydrocarbon resource but is no longer producing the hydrocarbon resource when the carbonated aqueous fluid is introduced thereto.

Element 11: wherein the salt minibasin is substantially devoid of a producible hydrocarbon resource.

Element 12: wherein the carbonated aqueous fluid is introduced adjacent to a bottom surface of the salt minibasin.

Element 13: wherein the method further comprises determining or estimating the density of the second aqueous fluid in the salt minibasin; selecting the first aqueous fluid such that, once combined with carbon dioxide to form the carbonated aqueous fluid, the carbonated aqueous fluid has a density greater than that of the second aqueous fluid in the salt minibasin; and forming the carbonated aqueous fluid for introduction into the salt minibasin.

Element 14: wherein the carbonated aqueous fluid further comprises a densifying additive.

Element 15: wherein the densifying additive comprises an additive selected from the group consisting of barite, hematite, calcium carbonate, siderite, a gel, a plurality of fines, and any combination thereof.

Element 16: wherein the method further comprises withdrawing a portion of the formation water from the open salt minibasin prior to or concurrently with introducing the carbonated aqueous fluid to open the salt minibasin.

Element 17: wherein the method further comprises combining at least some of the formation water withdrawn from the open salt minibasin with carbon dioxide to form at least a portion of the carbonated aqueous fluid; and optionally, combining the formation water with another aqueous fluid having a higher density than that of the formation water to form a combined aqueous fluid, and using the combined aqueous fluid as the first aqueous fluid to form the carbonated aqueous fluid.

Element 18: wherein the formation water comprises a brine and the carbonated aqueous fluid comprises a carbonated brine.

By way of non-limiting example, exemplary combinations applicable to A include, but are not limited to: 1 and 2; 1 and 4; 1, 2, and 4; 1 and 5; 1, 5, and 6; 1 and 5-7; 1 and 10; 1 and 11; 1 and 12; 1 and 13; 1 and 14; 2 and 4; 2, 5, and 6; 2 and 5-7; 2 and 10; 2 and 11; 2 and 12; 2 and 13; 2 and 14; 4 and 5; 4 and 6; 4, 6, and 7; 4-7; 4 and 10; 4 and 11; 4 and 12; 4 and 13; 4 and 14; 5 and 6; 5-7; 5 and 10; 5 and 11; 5 and 12; 5 and 13; 5 and 14; 10 and 11; 10 and 12; 10 and 13; 10 and 14; 11 and 12; 11 and 13; 11 and 14; 12 and 13; 12 and 14; and 13 and 14.

Additional embodiments disclosed herein include:

Clause 1. A method comprising:
providing a carbonated aqueous fluid containing carbon dioxide dissolved in a first aqueous fluid; and
introducing the carbonated aqueous fluid into a salt minibasin containing a second aqueous fluid having a density that is less than that of the carbonated aqueous fluid, the salt minibasin having a salt barrier defining one or more boundaries thereof;
   wherein the second aqueous fluid is displaced upward as the carbonated aqueous fluid is being introduced to the salt minibasin to form a barrier layer overlaying the carbonated aqueous fluid, and the barrier layer and the salt barrier maintain the carbonated aqueous fluid within the salt minibasin.

Clause 2. The method of clause 1, wherein the salt minibasin is an open salt minibasin having a concave shape.

Clause 3. The method of clause 1 or clause 2, wherein the second aqueous fluid within the salt minibasin comprises a formation water that is native to the salt minibasin.

Clause 4. The method of clause 3, wherein the formation water comprises a brine.

Clause 5. The method of any one of clauses 1-4, wherein the carbonated aqueous fluid comprises a carbonated brine or a carbonated aqueous salt solution.

Clause 6. The method of any one of clauses 1-5, further comprising:
withdrawing a portion of the second aqueous fluid from the salt minibasin prior to or concurrently with introducing the carbonated aqueous fluid to the salt minibasin.

Clause 7. The method of clause 6, further comprising:
combining at least some of the second aqueous fluid withdrawn from the salt minibasin with carbon dioxide to form at least a portion of the carbonated aqueous fluid.

Clause 8. The method of clause 7, further comprising:
combining the second aqueous fluid withdrawn from the salt minibasin with another aqueous fluid having a density higher than that of the second aqueous fluid to form a combined aqueous fluid; and
using the combined aqueous fluid as the first aqueous fluid to form the carbonated aqueous fluid.

Clause 9. The method of any one of clauses 1-8, wherein providing the carbonated aqueous fluid comprises dissolving carbon dioxide in the first aqueous fluid at a surface facility in fluid communication with an injection well penetrating the salt minibasin.

Clause 10. The method of any one of clauses 1-8, wherein providing the carbonated aqueous fluid comprises dissolving carbon dioxide in the first aqueous fluid as the carbon dioxide and the one or more first aqueous fluids are being introduced to the salt minibasin via an injection well.

Clause 11. The method of any one of clauses 1-10, wherein the salt minibasin previously produced a hydrocarbon resource but is no longer producing the hydrocarbon resource when the carbonated aqueous fluid is introduced thereto.

Clause 12. The method of any one of clauses 1-11, wherein the salt minibasin is substantially devoid of a producible hydrocarbon resource.

Clause 13. The method of any one of clauses 1-12, wherein the carbonated aqueous fluid is introduced adjacent to a bottom surface of the salt minibasin.

Clause 14. The method of any one of clauses 1-13, further comprising:
determining or estimating the density of the second aqueous fluid in the salt minibasin;
selecting the first aqueous fluid such that, once combined with carbon dioxide to form the carbonated aqueous fluid, the carbonated aqueous fluid has a density greater than that of the second aqueous fluid in the salt minibasin; and
forming the carbonated aqueous fluid for introduction into the salt minibasin.

Clause 15. The method of any one of clauses 1-14, wherein the carbonated aqueous fluid further comprises a densifying additive.

Clause 16. The method of clause 15, wherein the densifying additive comprises an additive selected from the group consisting of barite, hematite, calcium carbonate, siderite, a gel, a plurality of fines, and any combination thereof.

Clause 17. A method comprising:
providing a carbonated aqueous fluid containing carbon dioxide dissolved in a first aqueous fluid, the carbonated aqueous fluid comprising a carbonated brine or a carbonated aqueous salt solution; and
introducing the carbonated aqueous fluid into an open salt minibasin having a concave shape and a salt barrier defining one or more boundaries of the open salt minibasin, the open salt minibasin containing a formation water that is native to the open salt minibasin and has a density that is less than that of the carbonated aqueous fluid;
   wherein the formation water is displaced upward as the carbonated aqueous fluid is being introduced to the open salt minibasin to form a barrier layer overlaying the carbonated aqueous fluid, and the barrier layer and the salt barrier maintain the carbonated aqueous fluid within the open salt minibasin.

Clause 18. The method of clause 17, further comprising:
withdrawing a portion of the formation water from the open salt minibasin prior to or concurrently with introducing the carbonated aqueous fluid to open the salt minibasin.

Clause 19. The method of clause 18, further comprising:
combining at least some of the formation water withdrawn from the open salt minibasin with carbon dioxide to form at least a portion of the carbonated aqueous fluid; and
optionally, combining the formation water with another aqueous fluid having a higher density than that of the formation water to form a combined aqueous fluid, and using the combined aqueous fluid as the first aqueous fluid to form the carbonated aqueous fluid.

Clause 20. The method of any one of clauses 17-20, wherein the formation water comprises a brine and the carbonated aqueous fluid comprises a carbonated brine.

Clause 21. A method comprising:
providing a carbonated aqueous fluid containing carbon dioxide dissolved in a first aqueous fluid;
introducing the carbonated aqueous fluid into a salt minibasin having a salt barrier defining one or more boundaries thereof; and
introducing a second aqueous fluid into the salt minibasin before or after the carbonated aqueous fluid, the second aqueous fluid having a density lower than that of the carbonated aqueous fluid, and the second aqueous fluid forming a barrier layer overlaying the carbonated aqueous fluid in the salt minibasin;
   wherein the barrier layer and the salt barrier maintain the carbonated aqueous fluid within the salt minibasin.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A method comprising:
providing a carbonated aqueous fluid containing carbon dioxide dissolved in a first aqueous fluid; and
introducing the carbonated aqueous fluid into a salt minibasin containing a second aqueous fluid having a density that is less than that of the carbonated aqueous fluid, the salt minibasin having a salt barrier defining one or more boundaries thereof;
wherein the second aqueous fluid is displaced upward as the carbonated aqueous fluid is being introduced to the salt minibasin to form a barrier layer overlaying the carbonated aqueous fluid, and the barrier layer and the salt barrier maintain the carbonated aqueous fluid within the salt minibasin.

2. The method of claim 1, wherein the salt minibasin is an open salt minibasin having a concave shape.

3. The method of claim 1, wherein the second aqueous fluid within the salt minibasin comprises a formation water that is native to the salt minibasin.

4. The method of claim 3, wherein the formation water comprises a brine.

5. The method of claim 1, wherein the carbonated aqueous fluid comprises a carbonated brine or a carbonated aqueous salt solution.

6. The method of claim 1, further comprising:
withdrawing a portion of the second aqueous fluid from the salt minibasin prior to or concurrently with introducing the carbonated aqueous fluid to the salt minibasin.

7. The method of claim 6, further comprising:
combining at least some of the second aqueous fluid withdrawn from the salt minibasin with carbon dioxide to form at least a portion of the carbonated aqueous fluid.

8. The method of claim 7, further comprising:
combining the second aqueous fluid withdrawn from the salt minibasin with another aqueous fluid having a density higher than that of the second aqueous fluid to form a combined aqueous fluid; and
using the combined aqueous fluid as the first aqueous fluid to form the carbonated aqueous fluid.

9. The method of claim 1, wherein providing the carbonated aqueous fluid comprises dissolving carbon dioxide in the first aqueous fluid at a surface facility in fluid communication with an injection well penetrating the salt minibasin.

10. The method of claim 1, wherein providing the carbonated aqueous fluid comprises dissolving carbon dioxide in the first aqueous fluid as the carbon dioxide and the first aqueous fluid are being introduced to the salt minibasin via an injection well.

11. The method of claim 1, wherein the salt minibasin previously produced a hydrocarbon resource but is no longer producing the hydrocarbon resource when the carbonated aqueous fluid is introduced thereto.

12. The method of claim 1, wherein the salt minibasin is substantially devoid of a producible hydrocarbon resource.

13. The method of claim 1, wherein the carbonated aqueous fluid is introduced adjacent to a bottom surface of the salt minibasin.

14. The method of claim 1, further comprising:
determining or estimating the density of the second aqueous fluid in the salt minibasin;
selecting the first aqueous fluid such that, once combined with carbon dioxide to form the carbonated aqueous fluid, the carbonated aqueous fluid has a density greater than that of the second aqueous fluid in the salt minibasin; and
forming the carbonated aqueous fluid for introduction into the salt minibasin.

15. The method of claim 1, wherein the carbonated aqueous fluid further comprises a densifying additive.

16. The method of claim 15, wherein the densifying additive comprises an additive selected from the group consisting of barite, hematite, calcium carbonate, siderite, a gel, a plurality of fines, and any combination thereof.

17. A method comprising:
providing a carbonated aqueous fluid containing carbon dioxide dissolved in a first aqueous fluid, the carbonated aqueous fluid comprising a carbonated brine or a carbonated aqueous salt solution; and
introducing the carbonated aqueous fluid into an open salt minibasin having a concave shape and a salt barrier defining one or more boundaries of the open salt minibasin, the open salt minibasin containing a formation water that is native to the open salt minibasin and has a density that is less than that of the carbonated aqueous fluid;
wherein the formation water is displaced upward as the carbonated aqueous fluid is being introduced to the open salt minibasin to form a barrier layer overlaying the carbonated aqueous fluid, and the barrier layer and the salt barrier maintain the carbonated aqueous fluid within the open salt minibasin.

18. The method of claim 17, further comprising:
withdrawing a portion of the formation water from the open salt minibasin prior to or concurrently with introducing the carbonated aqueous fluid to open the salt minibasin.

19. The method of claim 18, further comprising:
combining at least some of the formation water withdrawn from the open salt minibasin with carbon dioxide to form at least a portion of the carbonated aqueous fluid; and
optionally, combining the formation water with another aqueous fluid having a higher density than that of the formation water to form a combined aqueous fluid, and using the combined aqueous fluid as the first aqueous fluid to form the carbonated aqueous fluid.

20. The method of claim 17, wherein the formation water comprises a brine and the carbonated aqueous fluid comprises a carbonated brine.

21. A method comprising:
providing a carbonated aqueous fluid containing carbon dioxide dissolved in a first aqueous fluid;
introducing the carbonated aqueous fluid into a salt minibasin having a salt barrier defining one or more boundaries thereof; and
introducing a second aqueous fluid into the salt minibasin before or after the carbonated aqueous fluid, the second aqueous fluid having a density lower than that of the carbonated aqueous fluid, and the second aqueous fluid forming a barrier layer overlaying the carbonated aqueous fluid in the salt minibasin;
wherein the barrier layer and the salt barrier maintain the carbonated aqueous fluid within the salt minibasin.
